(19) United States
(12) Patent Application Publication
(10) Pub. No.: US 2011/0064093 A1
(43) Pub. Date: Mar. 17, 2011

(54) METHOD AND APPARATUS FOR CONTROLLING DATA COMMUNICATION SESSIONS

(76) Inventors: Geoffrey A. Mattson, (US); Paul Jezioranski, Raleigh, NC (US)

(21) Appl. No.: 12/777,183

(22) Filed: May 10, 2010

Related U.S. Application Data
(60) Provisional application No. 61/176,755, filed on May 8, 2009.

(51) Int. Cl. H04J 3/24

(52) U.S. Cl. 370/474

(57) ABSTRACT

A highly scalable in-band mechanism for updating the state information in flows associated with new or ongoing sessions in a data communications network. The method addresses past scalability issues by using the inherent packet forwarding and flow state capabilities of a networking device to also perform configuration and event response updates to the flow's state information.

### CLAIM OF PRIORITY

This application claims the benefit of priority of prior-filed U.S. Provisional Patent Application No. 61/176,755, filed May 8, 2009, the complete contents of which is hereby incorporated herein by reference.

### BACKGROUND

1. Field of the Invention

The present method and apparatus is related generally to data communications systems, and more specifically to control of data communications sessions, and the individual flows which comprise them, within a data communications system.

2. Background

A large data communications system consists of multiple networks interconnected by devices such as switches, bridges, gateways, and routers. Some networking devices can perform all of these functions within a single unit. The primary purpose of these networking devices is to transfer data from one network end point or client to another end point. The networking devices contain specialized components for ensuring both correct and efficient transfer of data over optimum paths in the network between the source of the data and its destination. Data is transferred or forwarded in multiple bundles or packets. The packet structure conforms to certain conventions such as the Internet Protocol, version 4 (IPv4 or IP) or Multi-Protocol Label Switching (MPLS).

Currently, large IP networks are seldom controlled by a single authority. Instead, several independently controlled and administered networks are connected together. As Metcalfe's Law states, the value of a network increases exponentially with the number of other networks to which it connects. When IP networks are connected together, certain functions must be applied at the inter-connecting interfaces. These functions can allow the administrators of each network to control the way that their respective networks are accessed by other network, thereby keeping certain information confidential from the other network.

In the course of forwarding packets, a networking device can detect fields in each packet header that correlates multiple packets together into an entity generally denoted as a flow. A networking device that can identify flows and maintain the requisite flow state information is known as a flow-aware or flow state device. Packets within a flow are often transferred between two end-points as part of a specific session the two end-points are participating in. Single or multiple flows can be associated with a session if they are correlated by control protocol signaling information, or by signatures detected within the body of the packet. This flow-session association exists in session-aware devices called gateway routers.

One practical example of a session would be a video session between a client “player” computer and a video “server” computer, the latter of which may function as a library of videos. The video client and server may have separate flows for the visual and audio portions of the video session. A single video session could be part of a multi-session videoconferencing application comprised of hundreds of visual and audio flows to different endpoints in the network. Videoconferencing signaling protocols such as Session Initiation Protocol (SIP) could provide the gateway router mechanism for correlating the flows into individual video sessions. A multi-function networking device can therefore forward packets, be flow aware, and be session aware, all within a single physical unit.

A gateway can perform network protocol translation as well. Two connecting networks may use different protocols, such as IP Version 4 and 6, and a gateway function needs to translate between these two protocols. For example, one of the networks may wish to hide the addresses of certain users from the other network. The gateway function can provide a network address translation (“NAT”) or network address protocol translation (“NAPT”) function. Another gateway function is to initiate or terminate tunnels where packets are encapsulated in additional headers in order to traverse network segments transparently. Such an application involves maintaining flow state on each flow requiring IPv4-to-IPv6 translation, or IPv6-to-IPv4 translation. It can also involve maintaining session state information, with multiple flows from a common source or destination address being grouped under a single “subscriber” or “end user” session.

Once the networking device detects the presence of a flow, the networking device can then perform a multitude of functions pertaining to the flow (henceforth referred to as “flow state functions”, “flow state monitoring”, or “flow state control”), such as reporting statistics related to the flow (e.g. amount of data transferred in the flow, duration that the flow has existed) or such as monitoring the flow to determine whether a Service Level Agreement (SLA) bandwidth assigned to the flow or its associated session has been exceeded. In the event an SLA bandwidth is exceeded, some of the data in the flow could be discarded to bring the flow back within the agreement's bandwidth constraint.

In some cases, the static fields of a packet header, such as the IPv4 source and destination addresses, may be sufficient for the networking device to enable or disable the desired flow state functions. In other cases, the decision to enable or disable the desired flow state functions may involve discovery of header fields in only some of the packets. In yet other cases, the networking device examines the packet and traffic characteristics associated with the flow or its associated session, such as the sizes of the packets being transferred, the rate at which they are being transferred, or the duration that the flow or session exists. The networking devices may also communicate information regarding the session and its flows “out of band” using different control or routing protocols such as Border Gateway Protocol (BGP) or SIP. The information obtained from the control protocols about the end-point to end-point session in progress could then be used to monitor or control the session's characteristics, in the manners stated previously.

The flow- and session-aware networking device can identify and respond to changing conditions within the network and within the session and flow itself. One key issue to resolve has been the scale in which these flows and sessions exist in the network and the scale of their dynamic nature (i.e. how many flows and sessions are “connecting” and “disconnecting” to the network). A flow- and session-aware router that can maintain state information for tens of thousands of such events and millions of simultaneous flows and sessions requires significant hardware and software resources and capabilities.

A critical challenge to developing gateway functions in the past has been in making the requisite functions scale. Gateway functions often have to be applied to every packet in a stream of packets. The gateway must function quickly because delay beyond a certain bound will cause the affected session to fail. This is particularly true of delay-sensitive applications such as interactive voice and video. In addition, the gateway must be able to multiplex several sessions across single interfaces. It must be able to, for each packet, find information associated with a session, apply the instructions associated with that information to the packet, update the session configuration information associated with the packet, and send the packet on toward the destination. The gateway must be able to make updates to the session contexts quickly, as the session parameters could change at any time, either due to a configuration change, or a change in session control protocol state.

What is needed is an “in band” mechanism for updating the desired flow behavior or “treatment” within a session so that it is highly scalable to the number of flows and sessions and connections and disconnections that are needed in today's data communications networks. Current implementations typically use shared memory between the data and control planes to communicate flow state changes. However, a method and apparatus that uses direct “injection” of update information into the data path to facilitate changes in flow state information can be implemented with limited impact to the data plane's other functions, such as packet forwarding and classification.

### SUMMARY

The present method and apparatus is directed toward a flow- and session-aware network traffic routing, switching, or gateway device or toward a network monitoring device, with either of these devices existing within a larger data communication system. A flow- and session-aware routing, switching, gateway, or monitoring device can have network packet traffic passing through it, or in the case of a monitoring device, traffic may terminate at the device if it has been mirrored or duplicated in an upstream node, with one “copy” of the traffic passing to its assigned destination, and one copy being delivered to the monitoring device for the purpose of gathering statistics and/or characteristics pertaining to the traffic.

A device can be programmable and configurable, with specialized software and hardware within the device providing the means to configure and execute the desired flow and session state monitoring and control functions. A networking device can contain three fundamental functional blocks:
1. A data plane that can perform packet forwarding, classification, signature recognition, and flow state maintenance (i.e., “flowaware”) and can be optimized for high and deterministic execution speed with limited code complexity and memory elements.
2. A control plane that can maintains session state information (i.e., “session aware”) for special control and routing protocols that the networking devices can use to communicate with one another and can be optimized for code complexity, with large available memory and non-deterministic code execution speed.
3. A management plane that can configure and manage a networking device and can be optimized for ease of human-machine interaction. Configuration information can be passed down to the data and control planes, and can dictate how each plane will manage and control the flow and session state.

As packet traffic passes into the networking device, fields within the packet header and signatures within the packet body can be recognized by specialized data plane hardware and software within the networking device. Data plane hardware and software can designate the sequence of packets, or packet stream, to be part of a flow.

Data plane recognition of a header field or signature can trigger an event that can be relayed to the networking device's control plane. Once a control plane is made aware of the flows' presence by the data plane, it can then modify a data plane's treatment of the session to which the flows belong, based on static configuration information or dynamic event response mechanisms. These event response mechanisms could be triggered via control protocol information exchange. An event response could also be due to characteristic changes within the flow or session itself, such as crossing certain thresholds or matching certain secondary or tertiary signature patterns defined via configuration or control protocol information exchange.

A control plane can modify the data plane flow treatment by sending messages in-band into the data plane that apply to a session's specific flow. These messages can be sent repeatedly over the life of the flow to modify the same flow state information multiple times, or to modify different pieces of flow state information at different times in the flow's life. This represents a key aspect of the present method and apparatus: session-aware control plane modification of data plane flow state.

### BRIEF DESCRIPTION OF THE DRAWINGS

FIG. 1 depicts a diagram of a high-level overview of one embodiment of a data communications system or network of the present method.

FIG. 1a depicts a detail diagram of a packet.

FIG. 2 depicts a detail diagram of packet flow into the data plane processing elements and the establishment of flow state associated with the packets.

FIG. 3 depicts a chart showing flow and session hierarchy for one embodiment of the present method.

FIG. 4 depicts a detail view of the key internal components of a networking device in one embodiment of the present method.

FIG. 5 depicts a detail diagram of the various data plane elements that provide state information for the flow.

FIG. 6 depicts a detail diagram of the control plane session state information and control protocol state information

FIG. 7 depicts a diagram showing how the control plane updates flow state that was established by the stream of packets passing through a networking device.

FIG. 8 depicts a networked computer system capable of implementing the system and method described in FIGS. 1-7.

### DETAILED DESCRIPTION

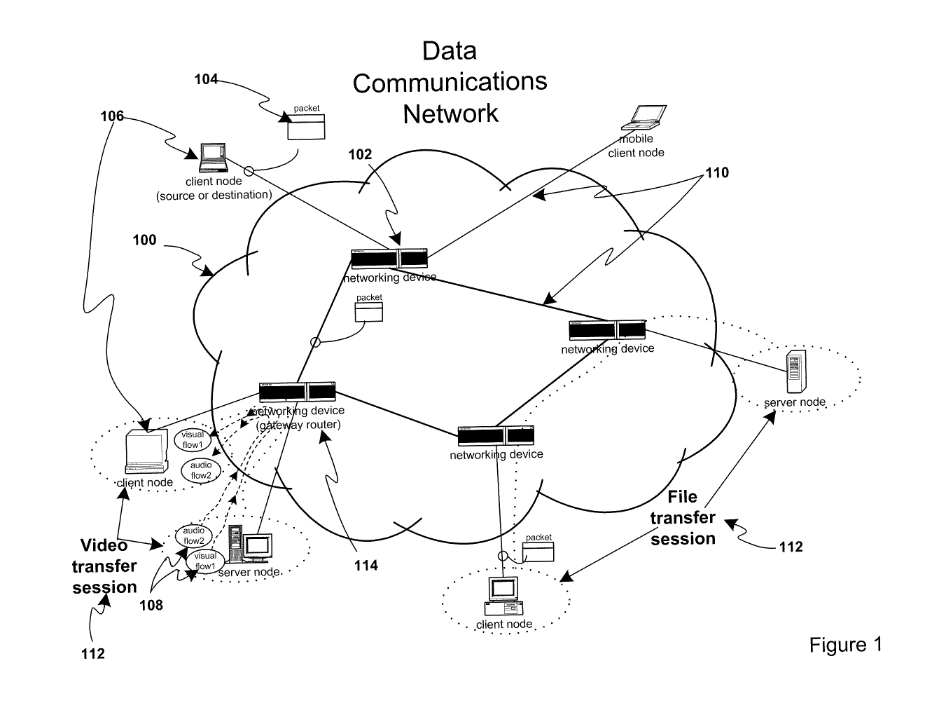

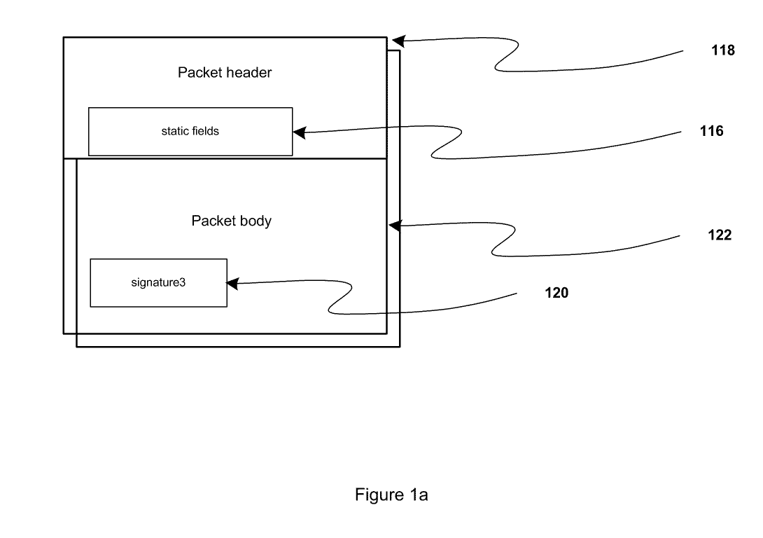

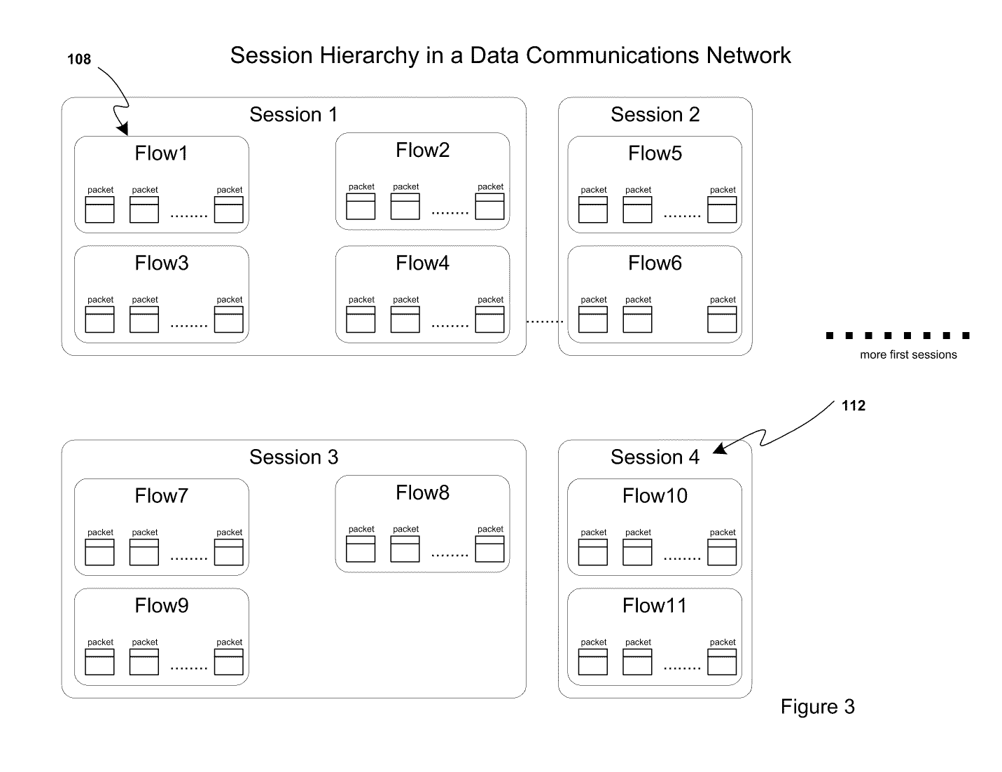

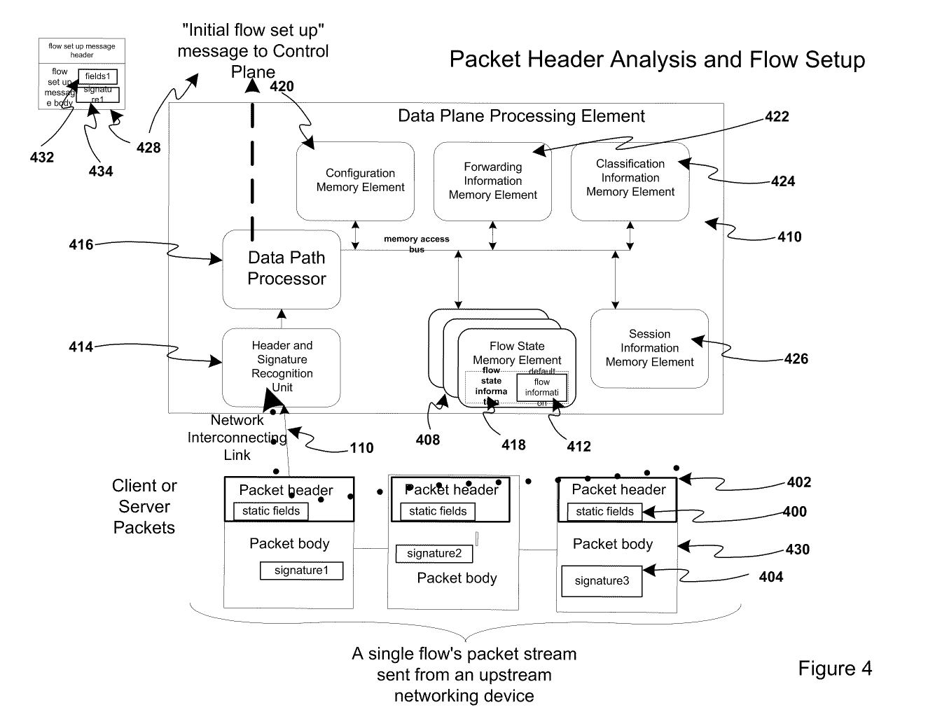

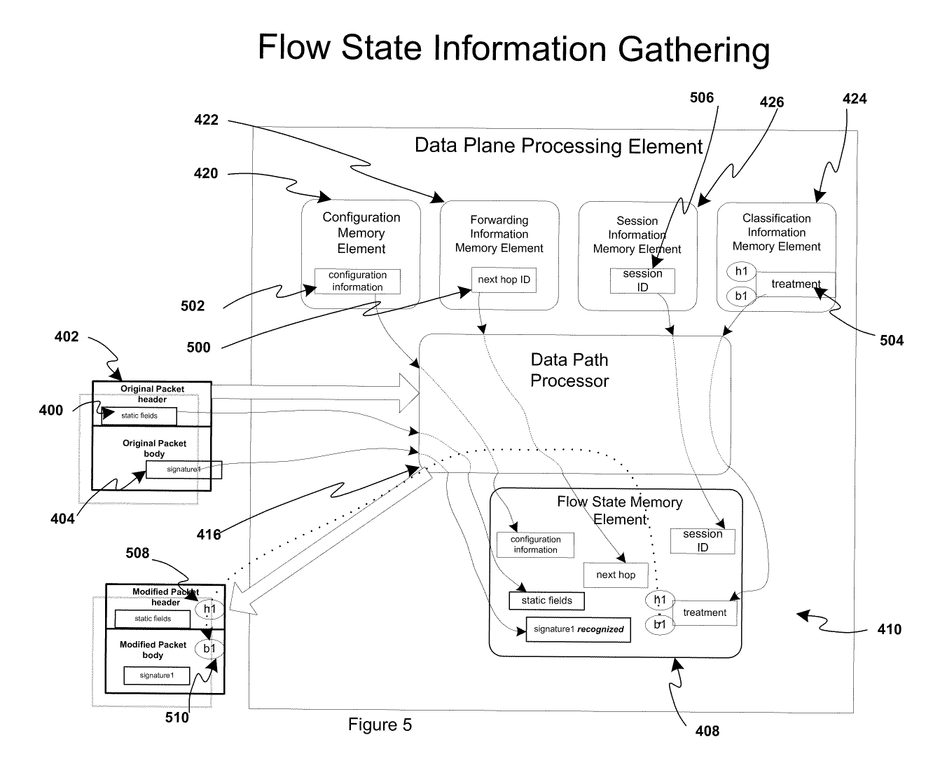

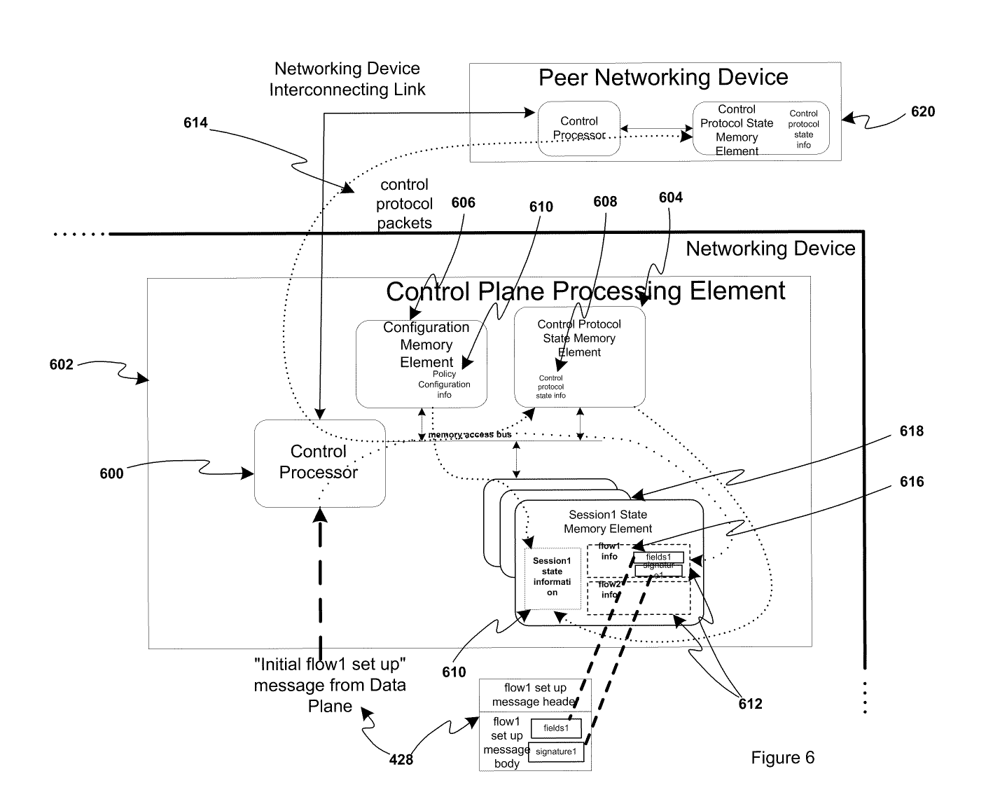

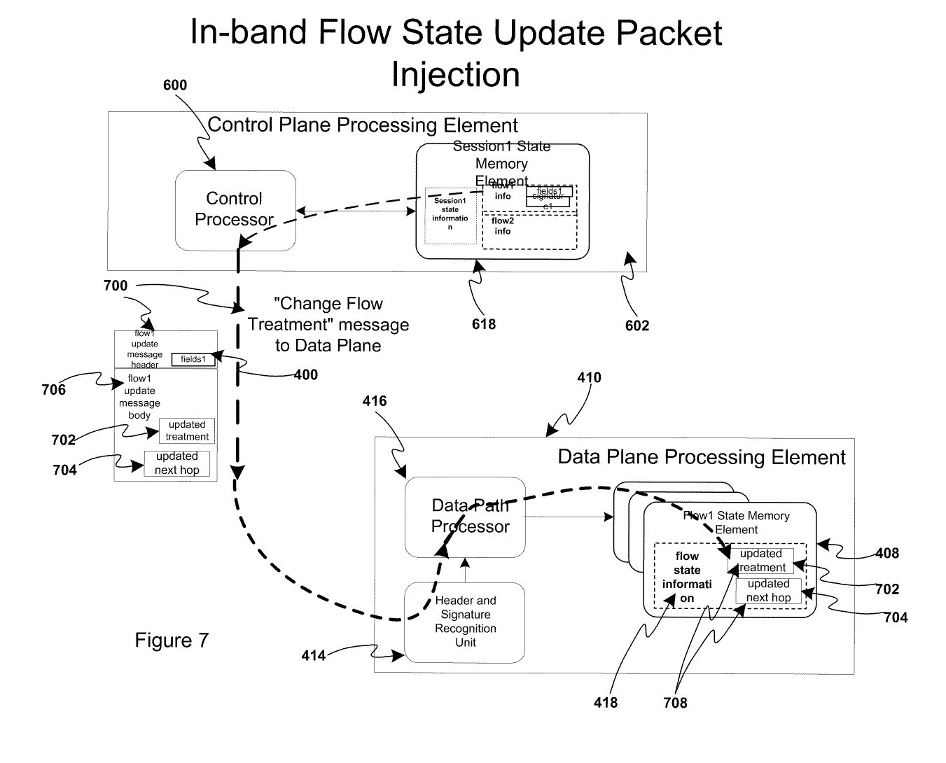

Various embodiment of the apparatus, system and method are described herein with reference to FIGS. 1-8.

As shown in FIG. 1, within a data communications network 100 can reside various networking devices 102, such as switches, gateways, routers, or any other known and/or convenient device. Devices 102 can pass packet-based traffic 104 from an originating source 106 to a designated destination 106 or destinations over interconnecting links 110 using protocols such as Internet Protocol, version 4, or any other known and/or convenient protocol. Each networking device 102 forwarding a packet 104 can also be referred to as a network hop 102. The operator of a data communications network 100 can have an interest in knowing the type and scope of packet traffic 104 within a network. A network operator can also find it useful to give preferential treatment (e.g., increased bandwidth) or punitive treatment (e.g., dropping packets above a certain bandwidth threshold) to certain types of traffic 104, depending on the level of service agreed between the network operator and the source and destination devices 106 and/or based on any other known and/or convenient reason. In some embodiments, network operators can also categorize types of flows 108 independently of whom the end users 106 are and give preferential or punitive treatment to those categorized types of flows 108. In some embodiments, the network operator can also give preferential or punitive treatment to certain types of sessions 112 at session-aware points in the network, such as at gateway routers 114 or any other known and/or convenient device. In some of these cases, and in some instances, to enable use of the mechanism described in the present method, networking devices 102 can identify traffic and/or categorize it into flows 108 and/or maintain historical state information over the life of the flow 108.

As shown in FIG. 1a, in some embodiments, packets 104 can contain fixed pre-defined fields 116 in the packet header 118 and non-fixed well-known signatures 120 in a packet body 122 that can uniquely identify not only the source and destination(s) devices 106, but the flows 108 that are operating between the devices. In some embodiments, packet 104 “marking” by altering packet header 118 fields can be another type of treatment to apply which downstream networking devices 102 can use to apply their own distinct treatments on the packets 104.

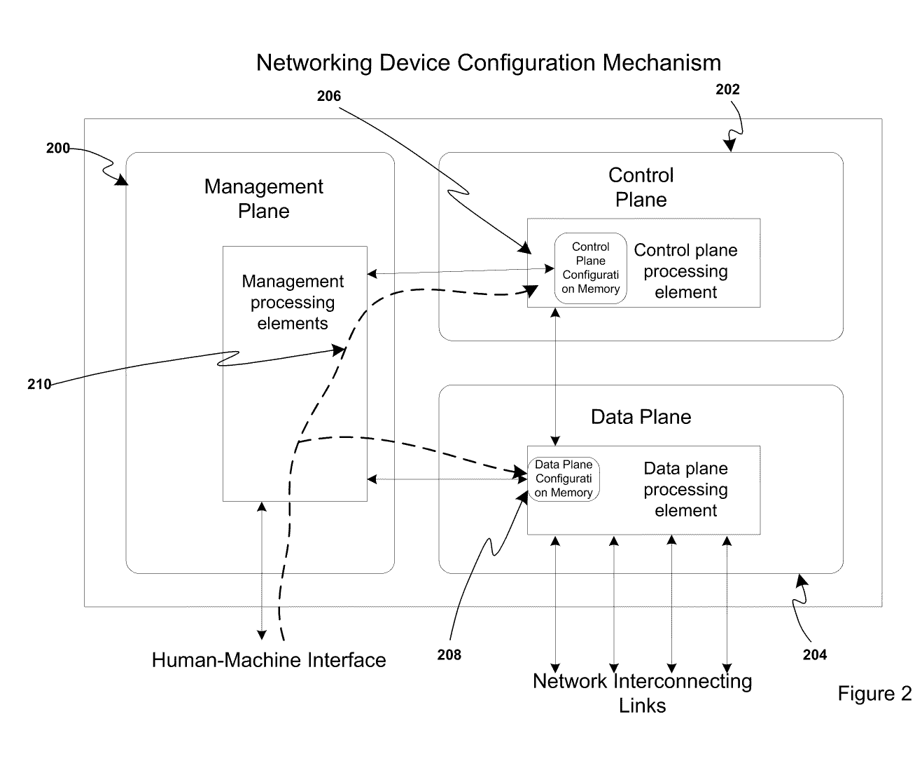

Given the desire to see and mediate the packet traffic 104 in the data communications network 100, the network operator can configure networking devices 102 to identify, categorize, and treat packet traffic 104. As shown in FIG. 2, a management plane 200 of a networking device 102 can facilitate a configuration, so that the elements handling the bearer and control traffic 104 in real time, a data plane 204 and control plane 202 respectively, can perform the desired operations on the packet traffic 104. Data plane 204 configuration information 208 can contain “identification” details to identify specified traffic 104 types or patterns. Control plane 202 configuration information 206 can contain both “identification” and “treatment” details. A control plane 202 can provide trigger mechanisms to a data plane 204 to change state information associated with packets 104 within a flow 108 from default information 412 established at flow state 408 creation time (i.e., when packets 104 are first identified).

With a control plane 202 and a data plane 204 configuration in place, bearer and control packets 104 transiting a network interconnecting link 110 can enter the networking device 100. A programmable and configurable data plane processing element 410 can scan the packets 104 for pre-defined packet header fields 400 and/or dynamic packet body signatures 404 to categorize the flow 108 to which the packet may 104 belong. Static header fields 400 can be stored in flow state memory elements 408 and can be associated with other packets 104 in the flow 108 that may have the same header fields 400. In some embodiments, packet body signatures 404 can exist in the “original” or “first” packet 104 received for the flow, so the packet header static fields 400 can become the primary mechanism for associating a packet 104 with a flow 108. In some embodiments, an “original,” or “first” packet of a flow 108 can transit the data path processing element 410. A data path processor 416 can extract at least some packet header fields 400 and store them in the flow state memory element 408. In some embodiments, a data path processor 416 can also access a flow state memory element 408 to initially establish and store the flow's state 408 information.

A data path processor 416 can obtain information pertaining to a flow 108 from one or more memories. Forwarding information memory 422 can contain a next hop 102 identifier and/or protocol-specific encapsulation information that can become part of the flow state 418. This information can be obtained using one or more packet header fields 400 in the case of Policy-Based Routing (PBR), or using a single field 400, such as an IP destination address prefix (in the case of IPv4 longest prefix match look-ups) or an MPLS label (in the case of MPLS packets 402). IN some embodiments, configuration information memory 420 can contain information specific to the networking device 102 that the network operator may desire to only apply to the specific networking device 102 or group of networking devices 102. A default flow 108 timeout interval would be an example of such “node-specific” information. Classification information memory 424 can contain packet treatment information 504 specific to the flow 108. Treatments such as service denial or acceptance, Service Level Agreements (e.g. maximum bandwidth for the flow 108), subscriber or end-user groups to which the flow 108 belongs, packet forwarding priority queues to use, and identifiers of counters to peg can be examples of classification information specific to a flow 108. Memory 424 can be indexed using multiple packet header fields 400 as a unique identifier. These can be the same fields 400 used to identify the flow 108 or other static or dynamic fields (such as the Differentiated Services Code Point or DSCP) from the packet 104. Note that even though, in some embodiments, the forwarding memory 422 and classification memory 424 can both use similar packet header fields 400 to index the respective memories, the information produced from each memory access (next hop identifier 500 and initial packet treatment 502, respectively) can be fundamentally unique. The in-band flow state 418 update mechanism described in the present disclosure can update any piece of the flow state information 418 at any time during the flow's 108 lifetime. Multiple flows 108 can be part of a single session 112. A control plane 202 can have visibility into the sessions 112 because it can maintain control protocol state information 608 and configuration information 206 associated with the sessions 112. In some embodiments, a control plane 202 can maintain session state information 610 which can contain the necessary flow information 612 for performing the in-band update 700 of data plane 204 flow state 418. In some embodiments, a control processor 600 within the control plane 202 can have policies 610 configured in its local memory. The control processor can send messages to a type of networking device 102 known as a policy server using standard control protocols 614 such as Diameter, Megaco/H.248, and Remote Authentication Dial In User Service (RADIUS), or any other known and/or convenient protocol. The control processor 600 can also participate in or have access to video or audio call or session 112 setup. In such embodiments, a control processor 600 can use a session signaling control protocol 614 such as Resource ReSerVation Protocol (RSVP), Session Initiation Protocol (SIP), Media Gateway Control Protocol (MGCP), H.323, or any other known and/or convenient control protocol. A control processor 600 can determine control for a session 112 via control protocol state information 608 obtained from control protocol packet 614 exchange with a peer networking device 102. In some embodiments, information to control the session 112 can be derived through protocol software in the control processor 600 that can be defined by known and/or convenient standards which can be standards defined by organizations such as the Internet Engineering Task Force (IETF) and/or the International Telecommunications Union (ITU-T). This software can have the necessary state machines and protocol definitions to properly identify each session 112 and which packet 104 protocol(s) can be used by the session 112. In some embodiments, a control processor 600 can also use standard routing protocols such as Border Gateway Protocol (BGP) or Label Distribution Protocol (LDP), and/or any other known and/or convenient routing protocol to communicate with neighbor networking devices 102.

In some embodiments, a control processor 600 can also determine how to control a session 112 by observing a stream of packets 104 associated with the sessions 112 themselves and by deriving session state information 610 from the stream characteristics and/or determining how such session state information 610 relates to policy information 610 which can be in place in the networking device 102. In some embodiments, via a flow configuration 420 option, a data path processor 416 can periodically send flow setup messages 428 to the control plane 202. These messages 428 can contain information about the flow 108, such as the static fields 400, body signatures 404, and/or any other know of convenient information and also flow lifetime, packet and byte counter, and/or other statistical flow 108 information and/or any other known, convenient and/or desirous information.

With session state information 610 in place in a control plane 202, a stream of packets 104 associated with the session 112 can commence through a data plane 204. In some embodiments, a first or original packet 104 of a flow 108 can result in the creation of flow state 408 information in the data plane processing elements 410, A header and signature recognition unit 414 can identify packet header fields 400 and packet body signatures 404 associated with a flow 108. A data path processor 416 can perform the forwarding 422, classification 424, session 426, and configuration 420 memory look-ups can store the results in a flow state memory 408. A data path processor 416 can perform any packet header 402 or body 430 modifications identified by the treatment information 504 prior to forwarding the packet 104 to the next hop 102. Treatment information 504 can indicate a certain bandwidth that the flow 108 may not exceed, in which case a packet 104 may be dropped. A packet header 402 modification (h1 508) or packet body modification (b1 510) can also be applied as a packet treatment 504.

In some embodiments, a data path processor 416 can also notify the control plane 202 of the presence of a flow 108 during the processing of an original packet 104 by sending a flow setup message 428. In some embodiments, this notification can occur on an original packet 104 arrival and/or at any other desired time and/or periodically as desired. A data path configuration memory 420 option can allow for periodic notification, meaning that a control plane 202 can be notified on a flow's 108 presence for every Nth packet 104 received (with “N” being configurable). This can address the potential for messages 428 getting lost in transition from a data plane 204 to a control plane 202. Repeated notification can also allow a control plane 202 to analyze flow 108 statistics that can also be placed in a message 428, such as how long a flow 108 has existed (lifetime), and how many packets 104 and bytes of data have been transferred in a flow 108 during its lifetime. A notification message 428 to a control plane 202 can contain pertinent flow information 418 that a control plane 202 may need to accurately locate a correct flow 108 in a data plane 204 when it sends the in-band flow state control message 700. A control plane notification message 428 for a flow 108 designated flow1 616 can contain packet header fields (fields) 432) and packet body signatures (signature1 434) associated with a flow 108. Further detail can be provided by sending a complete copy of the packet header 400 and a portion of the initial packet body 430 data that can contain further flow information 418. The amount of data sent to a control plane 202 can be limited to that necessary to identify flow1 616 and its characteristics. The limiting of data transmitted can improve the scalability of the method.

In some embodiments, a control processor 600 can receive a flow notification message 428 and can first associate flow1 616 with an existing session state memory element 618 denoted session1. This association can be based on information a control processor 600 obtains from the session configuration memory element 606 and a control protocol state memory element 604. In some embodiments, by examining packet header fields 400 (fields1 432) and signature 404 fields (signature1 434) in the notification message 428, a control processor 600 can determine the flow's 108 associated session 112. By way of non-limiting example, an IPv4 header 402 with:
protocol field set to Transport Control Protocol (TCP)
TCP source and destination port number 30000
IP source address 10.1.2.3
   can associate a flow 108 with a Voice over Internet Protocol (VoIP) session1 that could have been established within a networking device 102 by RSVP control protocol 614 exchange with a peer device 620. A control processor 600 can thereby associate flow1 616 with session1 in its session state information 610. Once the session 112 and flow 108 are associated, the information in the message 428 can be stored as part of the session state memory element 618.

In some embodiments, a data plane processing element 410 can continue to forward packets associated with the flows 108 as a control plane processing element 602 performs the session 112 and flow 108 association. Packets 104 can be forwarded using flow state information 418 obtained when an original packet 104 was received. At any time during the flow's 108 life, a control processor 600 can receive a configuration update from the network operator or a control protocol state 608 update from a peer networking device 620 for the associated session 112. In this event, a control processor 600 can then update the associated flow state information 418 via an in-band flow state update message 700 to the data plane 204. A control processor 600 can assemble a packet 104 that can function as a message 700 to a data path processor 416. A packet 104 can contain the packet header fields 400 that identify the flow 108 that is to be updated. A control processor 600 can also place the desired flow state update parameters in the body 430 of a packet 104. For example, if a new packet treatment 504 is desired, the new treatment 702 can be placed in a packet body 706. If a new next hop 102 is to be designated, the new next hop identifier 704 can be placed in a packet body 706. A control processor 600 can send a message 700 in the form of an injected packet to the data plane processing element 410, where the header and signature recognition unit 414 can associate the “message” 700 packet with a flow 108 to be updated. A data path processor 416 can then access flow state information 418 associated with a “message” 700 packet and can update a flow state 418 based on the parameters in a packet body 706. All subsequent packets 104 for a flow 108 that are received in the data path processor 416 can use the newly updated flow state parameters 708.

A control plane 202 can continue to send these flow state update messages 700 for the life of a flow 108. In the event that a flow 108 “closes” and a flow state memory element 408 is cleared or reused by another flow 108, a flow state update message 700 can still re-establish a flow state 418 in the event any new packets 104 for a flow 108 arrive on a network interconnecting link 110. A flow state update message 700 can contain all of the packet header fields 400 needed to establish a flow 108, so a flow state 408 can be recreated in a new flow state memory element 408.

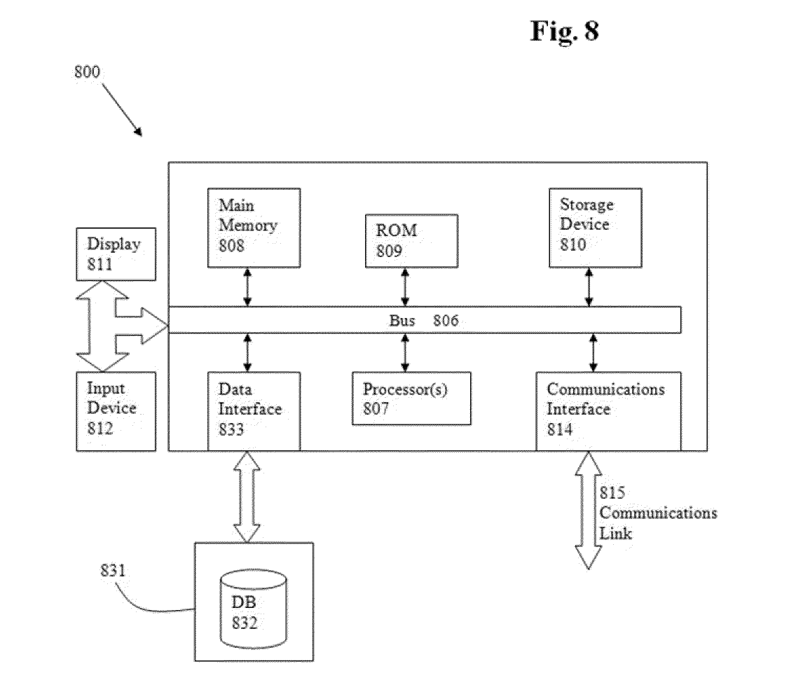

The execution of the sequences of instructions required to practice the embodiments may be performed by a computer system 800 as shown in FIG. 8. In an embodiment, execution of the sequences of instructions is performed by a single computer system 800. According to other embodiments, two or more computer systems 800 coupled by a communication link 815 may perform the sequence of instructions in coordination with one another. Although a description of only one computer system 800 will be presented below, however, it should be understood that any number of computer systems 800 may be employed to practice the embodiments.

A computer system 800 according to an embodiment will now be described with reference to FIG. 8, which is a block diagram of the functional components of a computer system 800. As used herein, the term computer system 800 is broadly used to describe any computing device that can store and independently run one or more programs.

Each computer system 800 may include a communication interface 814 coupled to the bus 806. The communication interface 814 provides two-way communication between computer systems 800. The communication interface 814 of a respective computer system 800 transmits and receives electrical, electromagnetic or optical signals that can include data streams representing various types of signal information, e.g., instructions, messages and data. A communication link 815 links one computer system 800 with another computer system 800. For example, the communication link 815 may be a LAN, in which case the communication interface 814 may be a LAN card, or the communication link 815 may be a PSTN, in which case the communication interface 814 may be an integrated services digital network (ISDN) card or a modem, or the communication link 815 may be the Internet, in which case the communication interface 814 may be a dial-up, cable or wireless modem.

A computer system 800 may transmit and receive messages, data, and instructions, including program, i.e., application, code, through its respective communication link 815 and communication interface 814. Received program code may be executed by the respective processor(s) 807 as it is received, and/or stored in the storage device 810, or other associated non-volatile media, for later execution.

In an embodiment, the computer system 800 operates in conjunction with a data storage system 831, e.g., a data storage system 831 that contains a database 832 that is readily accessible by the computer system 800. The computer system 800 communicates with the data storage system 831 through a data interface 833. A data interface 833, which is coupled to the bus 806, transmits and receives electrical, electromagnetic or optical signals that can include data streams representing various types of signal information, e.g., instructions, messages and data. In embodiments, the functions of the data interface 833 may be performed by the communication interface 814.

Computer system 800 includes a bus 806 or other communication mechanism for communicating instructions, messages and data, collectively, information, and one or more processors 807 coupled with the bus 806 for processing information. Computer system 800 also includes a main memory 808, such as a random access memory (RAM) or other dynamic storage device, coupled to the bus 806 for storing dynamic data and instructions to be executed by the processor(s) 807. The main memory 808 also may be used for storing temporary data, i.e., variables, or other intermediate information during execution of instructions by the processor(s) 807.

The computer system 800 may further include a read only memory (ROM) 809 or other static storage device coupled to the bus 806 for storing static data and instructions for the processor(s) 807. A storage device 810, such as a magnetic disk or optical disk, may also be provided and coupled to the bus 806 for storing data and instructions for the processor(s) 807.

A computer system 800 may be coupled via the bus 806 to a display device 811, such as, but not limited to, a cathode ray tube (CRT), for displaying information to a user. An input device 812, e.g., alphanumeric and other keys, is coupled to the bus 806 for communicating information and command selections to the processor(s) 807.

According to one embodiment, an individual computer system 800 performs specific operations by their respective processor(s) 807 executing one or more sequences of one or more instructions contained in the main memory 808. Such instructions may be read into the main memory 808 from another computer-usable medium, such as the ROM 809 or the storage device 810. Execution of the sequences of instructions contained in the main memory 808 causes the processor(s) 807 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 807. Such a medium may take many forms, including, but not limited to, non-volatile, volatile and transmission media. Non-volatile media, i.e., media that can retain information in the absence of power, includes the ROM 809, CD ROM, magnetic tape, and magnetic discs. Volatile media, i.e., media that cannot retain information in the absence of power, includes the main memory 808. Transmission media includes coaxial cables, copper wire and fiber optics, including the wires that comprise the bus 806. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention may be implemented in a variety of computer systems. The various techniques described herein may be implemented in hardware or software, or a combination of both. Preferably, the techniques are implemented in computer

What is claimed is:

1. A method of controlling information flow comprising:
receiving a first data packet comprising a header portion and a body portion;
determining a signature associated with said body portion of said first data packet;
determining a control signal based at least in part on said signature; and
modifying said body portion of said first data packet based at least in part based on said control signal.
